(19) United States
(12) Patent Application Publication
(10) Pub. No.: US 2023/0139396 A1
(43) Pub. Date: May 4, 2023

(54) USING LEARNED PHYSICAL KNOWLEDGE TO GUIDE FEATURE ENGINEERING

(71) Applicant: INTERNATIONAL BUSINESS MACHINES CORPORATION, Armonk, NY (US)

(72) Inventors: Amadou BA, Navan (IE); William Karol LYNCH, Rathkeale (IE); Fearghal O'DONNCHA, Aran Islands (IE); Theodore G. VAN KESSEL, Millbrook, NY (US)

(73) Assignee: INTERNATIONAL BUSINESS MACHINES CORPORATION, Armonk, NY (US)

(21) Appl. No.: 17/453,121

(22) Filed: Nov. 1, 2021

(51) Int. Cl. G06N 5/02; G06N 20/00

(52) U.S. Cl. CPC G06N 5/02; G06N 20/00

(57) ABSTRACT

Embodiments for using learned physical knowledge to guide feature engineering in a computing environment by a processor. Physical knowledge data associated with a dataset may be learned. The physical knowledge data may be translated into a plurality of features for one or more automated feature engineering models to execute for one or more prediction and monitoring operations, wherein the plurality of features represent relationships between the physical knowledge data.

### BACKGROUND OF THE INVENTION

### Field of the Invention

The present invention relates in general to computing systems, and more particularly, to various embodiments for using learned physical knowledge to guide feature engineering by a processor.

### Description of the Related Art

In today's society, consumers, businesspersons, educators, and others communicate over a wide variety of mediums in real time, across great distances, and many times without boundaries or borders. With the increased usage of computing networks, such as the Internet, humans are currently inundated and overwhelmed with the amount of information available to them from various structured and unstructured sources. Due to the recent advancement of information technology and the growing popularity of the Internet, a wide variety of computer systems have been used in machine learning. Machine learning is a form of artificial intelligence (“AI”) that is employed to allow computers to evolve behaviors based on empirical data.

### SUMMARY OF THE INVENTION

According to an embodiment of the present invention, a method for using learned physical knowledge to guide feature engineering in a computing environment, by one or more processors, is depicted. Physical knowledge data associated with a dataset may be learned. The physical knowledge data may be translated into a plurality of features for one or more automated feature engineering models to execute for one or more prediction and monitoring operations, wherein the plurality of features represent relationships between the physical knowledge data.

An embodiment includes a computer usable program product. The computer usable program product includes a computer-readable storage device, and program instructions stored on the storage device.

An embodiment includes a computer system. The computer system includes a processor, a computer-readable memory, and a computer-readable storage device, and program instructions stored on the storage device for execution by the processor via the memory.

Thus, in addition to the foregoing exemplary method embodiments, other exemplary system and computer product embodiments are provided.

### BRIEF DESCRIPTION OF THE DRAWINGS

In order that the advantages of the invention will be readily understood, a more particular description of the invention briefly described above will be rendered by reference to specific embodiments that are illustrated in the appended drawings. Understanding that these drawings depict only typical embodiments of the invention and are not therefore to be considered to be limiting of its scope, the invention will be described and explained with additional specificity and detail through the use of the accompanying drawings, in which:

FIG. 1 is a block diagram depicting an exemplary cloud computing node according to an embodiment of the present invention.

FIG. 2 depicts a cloud computing environment according to an embodiment of the present invention.

FIG. 3 depicts abstraction model layers according to an embodiment of the present invention.

FIG. 4 is an additional block diagram depicting an exemplary functional relationship between various aspects of the present invention.

FIG. 5 is a block diagram depicting using learned physical knowledge to guide feature engineering in a computing environment according to an embodiment of the present invention.

FIG. 6 is an additional block diagram depicting using learned physical knowledge to guide feature engineering in a computing environment according to an embodiment of the present invention.

FIG. 7 is a block diagram depicting an additional exemplary operations using learned physical knowledge to guide feature engineering in a computing environment according to an embodiment of the present invention.

FIG. 8 is a flowchart diagram depicting an exemplary method for using learned physical knowledge to guide feature engineering in a computing environment according to an embodiment of the present invention.

FIG. 9 is a flowchart diagram depicting an additional exemplary method for using learned physical knowledge to guide feature engineering in a computing environment according to an embodiment of the present invention.

### DETAILED DESCRIPTION OF THE DRAWINGS

Over the last decade, data analytics has become an important trend in many industries including e-commerce, healthcare, manufacture and more. The reasons behind the increasing interest are the availability of data, variety of open-source machine learning tools and powerful computing resources. Nevertheless, machine learning tools for analyzing data are still difficult to use and automate, since a typical data analytics project contains many tasks that have not been fully automated yet. For example, predictive data analytics project have attempted to provide automation tools yet there still remains a need to fully automate the various steps. Feature engineering, the cornerstone of successful predictive modeling, is one of the most important and time consuming tasks in predictive analytic operations because it prepares inputs to machine learning models, thus deciding how machine learning models will perform. It is difficult to know a priori which features are most optimal and what transformations or combination of those features most closely represents system dynamics and response. In practice, feature engineering is guided by domain expertise, user knowledge and intuition, together with an iterative, trial-and-error approach. Feature engineering is a critical step in data science, which impacts the final prediction results. Feature engineering involves understanding domain knowledge and data exploration to discover relevant hand-crafted features from raw data.

“Features,” for example, are the observations or characteristics on which a model is built. The process of deriving a new abstract feature based on the given data is broadly referred to as “feature engineering.” Feature engineering is typically done using one of the many mathematical or statistical functions called “transformations.” A key step in data science projects is the transformation of raw data into “features” that can be used as inputs for machine learning models. Often, the raw data is stored across various tables in a relational database and need to be combined in various ways. That is, “feature engineering” builds “features” out of existing data, which is often times spread out across multiple related tables. The relevant information needs to be extracted from the data and placed into a single table, which can then be used to train a machine learning model. What makes the task of effective feature engineering hard is that there are a vast number of options of transformations a data scientist could perform. Moreover, working through those options with the trial and error of applying transformations and assessing their impact is very time consuming, often infeasible to perform thoroughly. On the other hand, feature engineering is central to producing accurate models, which presents a dilemma to a data scientist on how much time to devote to it.

Automated feature engineering attempts to automatically created candidate features from a dataset, that may be automatically selected from given raw dataset and used for training. Automated feature engineering attempts to assists the data scientists by reducing manual efforts required to generate features from a raw dataset in a data science project. This helps data scientists save a significant amount of time in data science project.

Currently, it is common for new features to be engineered from a provided feature set that either augment or replace portions of an existing set. These engineered features are essentially calculated fields, based on the values of the other features. Engineering such features is primarily a manual, time-consuming task. Additionally, each type of model will respond differently to different types of engineered features and the optimal set of features is computed based on computationally expensive trial and error. Further, it requires significant user expertise and domain knowledge to identify the most appropriate feature engineering. Existing feature engineering rely heavily on empirical trial-and-error. However, in many real-world applications, dynamics can be explained by well-founded physics equations that represent the process. As part of the process of hand-crafting features, these physical relationships are often known by the data scientist but extremely difficult to uncover in the data from a purely empirical trial-and-error approach. Examples of these physical knowledge that a data scientist might know are that, drag is a function of the square of velocity (the relationship between drag force F_{D} and velocity, v, can be expressed mathematically as F_{D} ∝ v²), or that in fluid dynamics, temperature is dependent on water depth (warmer water overlays cooler).

While machine learning is founded on the principle of learning from data rather than rule-based (or governing equations), using information from these known relationships can improve model performance. Examples include the Navier-Stokes equations governing fluid flow or convection-diffusion-reaction equations governing transport in a fluid. However, it is not feasible to specify a priori which rules or physical equations apply for a given dataset. Accordingly, the present invention provides for learning one or more physics (e.g., law of physics) encoded in a dataset and transforms a provided feature set into a new feature encapsulating these physics relationship based on the learned physics-based knowledge.

In some implementations, the present invention provides for learning physics and automated feature engineering approaches to guide machine learning model prediction and monitoring. New or additional features, which may be hidden to machine learning model, may be learned. Implicit combinations of physics information and hidden relationships may be provided by learning by targeted feature engineering. The present invention provides for physics-guided dimensional reduction or feature generatuin that is guided by both data and physical consistency. The present invention relies on and use an automated feature engineering (“AFE”) pipeline that allows encoding of physics equations (e.g., Wolfram alpha). That is, data driven approaches are applied that characterizes the physical equations and basis functions that characterize a raw dataset. Once these relationships are established, transformations are applied to the selected columns from the raw dataset to map to the new features defined by the physical equations and basis functions extracted above. A variety of existing computational knowledge intelligence or artificial intelligence (“AI”) frameworks may be used to apply the given transformations (based on extracted equations) to the raw dataset such as, for example, Wolfram Alpha®, Microsoft® Math Solver, and Mathematica®). A computed equation may be passed and sent to an automated feature engineering primitives' pipeline. Thus, the present invention provides for improved modeling accuracy based on inclusion of physically meaningful feature, improved model interpretability as the transformed features represent physical processes and dynamics, and improved representation of complex system dynamics such as weather forecasting by combining machine learning with well-founded physics.

In other various implementations, the present invention provides for using learned physical knowledge to guide feature engineering in a computing environment, by one or more processors, is depicted. Physical knowledge data associated with a dataset may be learned. The physical knowledge data may be translated into a plurality of features for one or more automated feature engineering models to execute for one or more prediction and monitoring operations, where the plurality of features represent relationships between the physical knowledge data.

Thus, the present invention provides for learning physical knowledge and training a machine learning with the physical knowledge for automated feature engineering of physical systems. An automated feature engineering pipeline provides for and enables encoding of physics equations for improved machine learning modeling, prediction and monitoring.

It is understood in advance that although this disclosure includes a detailed description on cloud computing, implementation of the teachings recited herein are not limited to a cloud-computing environment. Rather, embodiments of the present invention are capable of being implemented in conjunction with any other type of computing environment now known or later developed.

Cloud computing is a model of service delivery for enabling convenient, on-demand network access to a shared pool of configurable computing resources (e.g., networks, network bandwidth, servers, processing, memory, storage, applications, virtual machines, and services) that can be rapidly provisioned and released with minimal management effort or interaction with a provider of the service. This cloud model may include at least five characteristics, at least three service models, and at least four deployment models.

Characteristics are as follows:

On-demand self-service: a cloud consumer can unilaterally provision computing capabilities, such as server time and network storage, as needed automatically without requiring human interaction with the service's provider.

Broad network access: capabilities are available over a network and accessed through standard mechanisms that promote use by heterogeneous thin or thick client platforms (e.g., mobile phones, laptops, and PDAs).

Resource pooling: the provider's computing resources are pooled to serve multiple consumers using a multi-tenant model, with different physical and virtual resources dynamically assigned and reassigned according to demand. There is a sense of location independence in that the consumer generally has no control or knowledge over the exact location of the provided resources but may be able to specify location at a higher level of abstraction (e.g., country, state, or datacenter).

Rapid elasticity: capabilities can be rapidly and elastically provisioned, in some cases automatically, to quickly scale out and rapidly released to quickly scale in. To the consumer, the capabilities available for provisioning often appear to be unlimited and can be purchased in any quantity at any time.

Measured service: cloud systems automatically control and optimize resource use by leveraging a metering capability at some level of abstraction appropriate to the type of service (e.g., storage, processing, bandwidth, and active user accounts). Resource usage can be monitored, controlled, and reported providing transparency for both the provider and consumer of the utilized service.

Service Models are as follows:

Software as a Service (SaaS): the capability provided to the consumer is to use the provider's applications running on a cloud infrastructure. The applications are accessible from various client devices through a thin client interface such as a web browser (e.g., web-based e-mail). The consumer does not manage or control the underlying cloud infrastructure including network, servers, operating systems, storage, or even individual application capabilities, with the possible exception of limited user-specific application configuration settings.

Platform as a Service (PaaS): the capability provided to the consumer is to deploy onto the cloud infrastructure consumer-created or acquired applications created using programming languages and tools supported by the provider. The consumer does not manage or control the underlying cloud infrastructure including networks, servers, operating systems, or storage, but has control over the deployed applications and possibly application hosting environment configurations.

Infrastructure as a Service (IaaS): the capability provided to the consumer is to provision processing, storage, networks, and other fundamental computing resources where the consumer is able to deploy and run arbitrary software, which can include operating systems and applications. The consumer does not manage or control the underlying cloud infrastructure but has control over operating systems, storage, deployed applications, and possibly limited control of select networking components (e.g., host firewalls).

Deployment Models are as follows:

Private cloud: the cloud infrastructure is operated solely for an organization. It may be managed by the organization or a third party and may exist on-premises or off-premises.

Community cloud: the cloud infrastructure is shared by several organizations and supports a specific community that has shared concerns (e.g., mission, security requirements, policy, and compliance considerations). It may be managed by the organizations or a third party and may exist on-premises or off-premises.

Public cloud: the cloud infrastructure is made available to the general public or a large industry group and is owned by an organization selling cloud services.

Hybrid cloud: the cloud infrastructure is a composition of two or more clouds (private, community, or public) that remain unique entities but are bound together by standardized or proprietary technology that enables data and application portability (e.g., cloud bursting for load-balancing between clouds).

A cloud computing environment is service oriented with a focus on statelessness, low coupling, modularity, and semantic interoperability. At the heart of cloud computing is an infrastructure comprising a network of interconnected nodes.

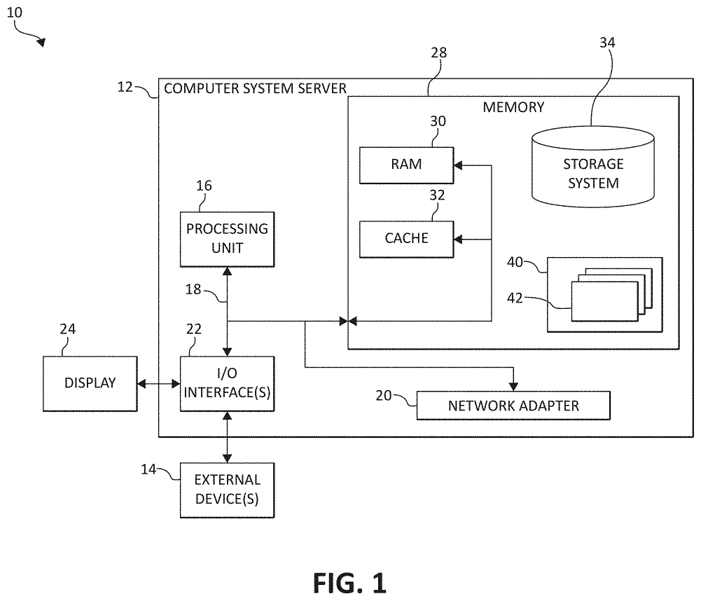

Referring now to FIG. 1, a schematic of an example of a cloud computing node is shown. Cloud computing node 10 is only one example of a suitable cloud computing node and is not intended to suggest any limitation as to the scope of use or functionality of embodiments of the invention described herein. Regardless, cloud computing node 10 is capable of being implemented and/or performing any of the functionality set forth hereinabove.

In cloud computing node 10 there is a computer system/server 12, which is operational with numerous other general purpose or special purpose computing system environments or configurations. Examples of well-known computing systems, environments, and/or configurations that may be suitable for use with computer system/server 12 include, but are not limited to, personal computer systems, server computer systems, thin clients, thick clients, hand-held or laptop devices, multiprocessor systems, microprocessor-based systems, set top boxes, programmable consumer electronics, network PCs, minicomputer systems, mainframe computer systems, and distributed cloud computing environments that include any of the above systems or devices, and the like.

Computer system/server 12 may be described in the general context of computer system-executable instructions, such as program modules, being executed by a computer system. Generally, program modules may include routines, programs, objects, components, logic, data structures, and so on that perform particular tasks or implement particular abstract data types. Computer system/server 12 may be practiced in distributed cloud computing environments where tasks are performed by remote processing devices that are linked through a communications network. In a distributed cloud computing environment, program modules may be located in both local and remote computer system storage media including memory storage devices.

As shown in FIG. 1, computer system/server 12 in cloud computing node 10 is shown in the form of a general-purpose computing device. The components of computer system/server 12 may include, but are not limited to, one or more processors or processing units 16, a system memory 28, and a bus 18 that couples various system components including system memory 28 to processor 12.

Bus 18 represents one or more of any of several types of bus structures, including a memory bus or memory controller, a peripheral bus, an accelerated graphics port, and a processor or local bus using any of a variety of bus architectures. By way of example, and not limitation, such architectures include Industry Standard Architecture (ISA) bus, Micro Channel Architecture (MCA) bus, Enhanced ISA (EISA) bus, Video Electronics Standards Association (VESA) local bus, and Peripheral Component Interconnects (PCI) bus.

Computer system/server 12 typically includes a variety of computer system readable media. Such media may be any available media that is accessible by computer system/server 12, and it includes both volatile and non-volatile media, removable and non-removable media.

System memory 28 can include computer system readable media in the form of volatile memory, such as random access memory (RAM) 30 and/or cache memory 32. Computer system/server 12 may further include other removable/non-removable, volatile/non-volatile computer system storage media. By way of example only, storage system 34 can be provided for reading from and writing to a non-removable, non-volatile magnetic media (not shown and typically called a “hard drive”). Although not shown, a magnetic disk drive for reading from and writing to a removable, non-volatile magnetic disk (e.g., a “floppy disk”), and an optical disk drive for reading from or writing to a removable, non-volatile optical disk such as a CD-ROM, DVD-ROM or other optical media can be provided. In such instances, each can be connected to bus 18 by one or more data media interfaces. As will be further depicted and described below, system memory 28 may include at least one program product having a set (e.g., at least one) of program modules that are configured to carry out the functions of embodiments of the invention.

Program/utility 40, having a set (at least one) of program modules 42, may be stored in system memory 28 by way of example, and not limitation, as well as an operating system, one or more application programs, other program modules, and program data. Each of the operating system, one or more application programs, other program modules, and program data or some combination thereof, may include an implementation of a networking environment. Program modules 42 generally carry out the functions and/or methodologies of embodiments of the invention as described herein.

Computer system/server 12 may also communicate with one or more external devices 14 such as a keyboard, a pointing device, a display 24, etc.; one or more devices that enable a user to interact with computer system/server 12; and/or any devices (e.g., network card, modem, etc.) that enable computer system/server 12 to communicate with one or more other computing devices. Such communication can occur via Input/Output (I/O) interfaces 22. Still yet, computer system/server 12 can communicate with one or more networks such as a local area network (LAN), a general wide area network (WAN), and/or a public network (e.g., the Internet) via network adapter 20. As depicted, network adapter 20 communicates with the other components of computer system/server 12 via bus 18. It should be understood that although not shown, other hardware and/or software components could be used in conjunction with computer system/server 12. Examples, include, but are not limited to: microcode, device drivers, redundant processing units, external disk drive arrays, RAID systems, tape drives, and data archival storage systems, etc.

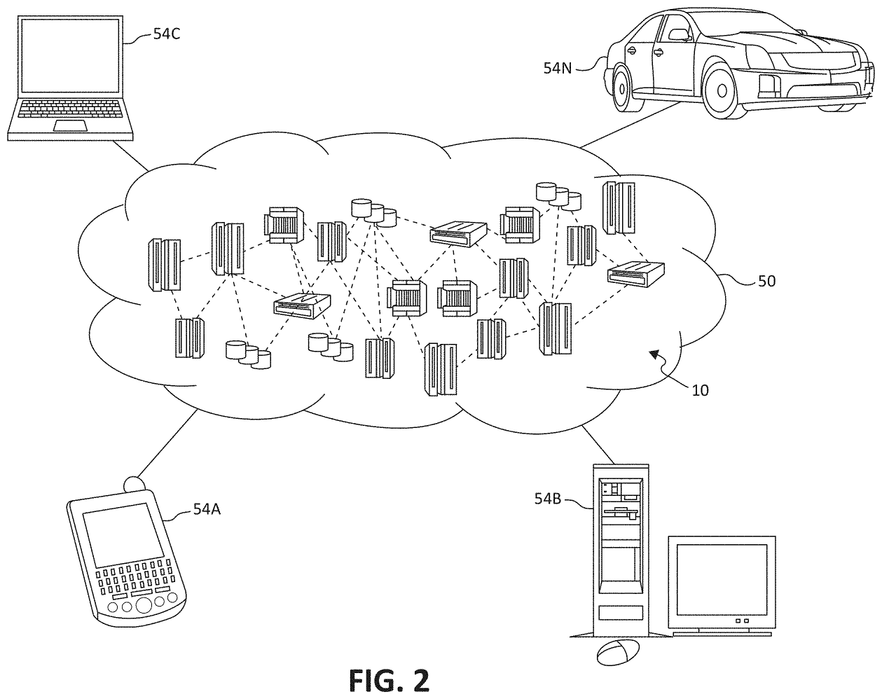

Referring now to FIG. 2, illustrative cloud computing environment 50 is depicted. As shown, cloud computing environment 50 comprises one or more cloud computing nodes 10 with which local computing devices used by cloud consumers, such as, for example, personal digital assistant (PDA) or cellular telephone 54A, desktop computer 54B, laptop computer 54C, and/or automobile computer system 54N may communicate. Nodes 10 may communicate with one another. They may be grouped (not shown) physically or virtually, in one or more networks, such as Private, Community, Public, or Hybrid clouds as described hereinabove, or a combination thereof. This allows cloud computing environment 50 to offer infrastructure, platforms and/or software as services for which a cloud consumer does not need to maintain resources on a local computing device. It is understood that the types of computing devices 54A-N shown in FIG. 2 are intended to be illustrative only and that computing nodes 10 and cloud computing environment 50 can communicate with any type of computerized device over any type of network and/or network addressable connection (e.g., using a web browser).

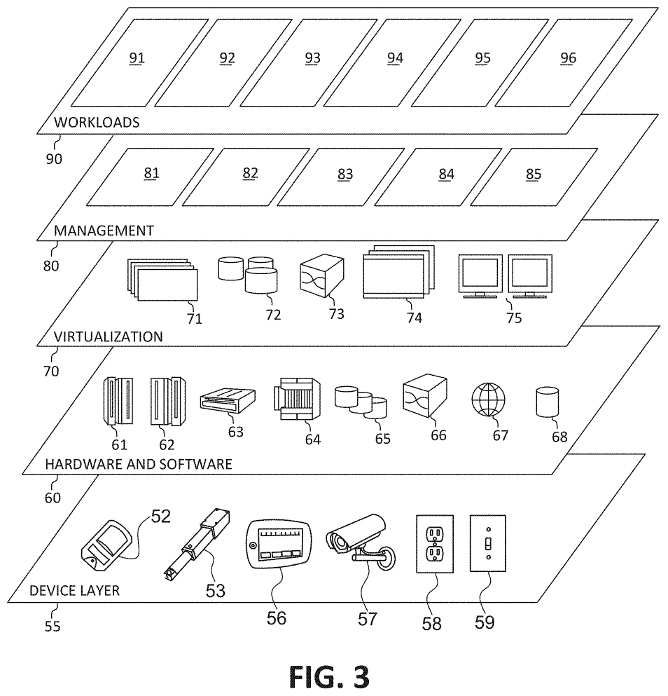

Referring now to FIG. 3, a set of functional abstraction layers provided by cloud computing environment 50 (FIG. 2) is shown. It should be understood in advance that the components, layers, and functions shown in FIG. 3 are intended to be illustrative only and embodiments of the invention are not limited thereto. As depicted, the following layers and corresponding functions are provided:

Device layer 55 includes physical and/or virtual devices, embedded with and/or standalone electronics, sensors, actuators, and other objects to perform various tasks in a cloud computing environment 50. Each of the devices in the device layer 55 incorporates networking capability to other functional abstraction layers such that information obtained from the devices may be provided thereto, and/or information from the other abstraction layers may be provided to the devices. In one embodiment, the various devices inclusive of the device layer 55 may incorporate a network of entities collectively known as the “internet of things” (IoT). Such a network of entities allows for intercommunication, collection, and dissemination of data to accomplish a great variety of purposes, as one of ordinary skill in the art will appreciate.

Device layer 55 as shown includes sensor 52, actuator 53, “learning” thermostat 56 with integrated processing, sensor, and networking electronics, camera 57, controllable household outlet/receptacle 58, and controllable electrical switch 59 as shown. Other possible devices may include, but are not limited to various additional sensor devices, networking devices, electronics devices (such as a remote control device), additional actuator devices, so called “smart” appliances such as a refrigerator or washer/dryer, and a wide variety of other possible interconnected objects.

Hardware and software layer 60 includes hardware and software components. Examples of hardware components include: mainframes 61; RISC (Reduced Instruction Set Computer) architecture based servers 62; servers 63; blade servers 64; storage devices 65; and networks and networking components 66. In some embodiments, software components include network application server software 67 and database software 68.

Virtualization layer 70 provides an abstraction layer from which the following examples of virtual entities may be provided: virtual servers 71; virtual storage 72; virtual networks 73, including virtual private networks; virtual applications and operating systems 74; and virtual clients 75.

In one example, management layer 80 may provide the functions described below. Resource provisioning 81 provides dynamic procurement of computing resources and other resources that are utilized to perform tasks within the cloud computing environment. Metering and Pricing 82 provides cost tracking as resources are utilized within the cloud computing environment, and billing or invoicing for consumption of these resources. In one example, these resources may comprise application software licenses. Security provides identity verification for cloud consumers and tasks, as well as protection for data and other resources. User portal 83 provides access to the cloud computing environment for consumers and system administrators. Service level management 84 provides cloud computing resource allocation and management such that required service levels are met. Service Level Agreement (SLA) planning and fulfillment 85 provides pre-arrangement for, and procurement of, cloud computing resources for which a future requirement is anticipated in accordance with an SLA.

Workloads layer 90 provides examples of functionality for which the cloud computing environment may be utilized. Examples of workloads and functions which may be provided from this layer include: mapping and navigation 91; software development and lifecycle management 92; virtual classroom education delivery 93; data analytics processing 94; transaction processing 95; and, in the context of the illustrated embodiments of the present invention, various workloads and functions 96 for providing efficient automated feature engineering during an online scoring phase. In addition, workloads and functions 96 for providing efficient automated feature engineering during an online scoring phase may include such operations as data analytics, data analysis, and as will be further described, notification functionality. One of ordinary skill in the art will appreciate that the workloads and functions 96 for providing efficient automated feature engineering during an online scoring phase may also work in conjunction with other portions of the various abstractions layers, such as those in hardware and software 60, virtualization 70, management 80, and other workloads 90 (such as data analytics processing 94, for example) to accomplish the various purposes of the illustrated embodiments of the present invention.

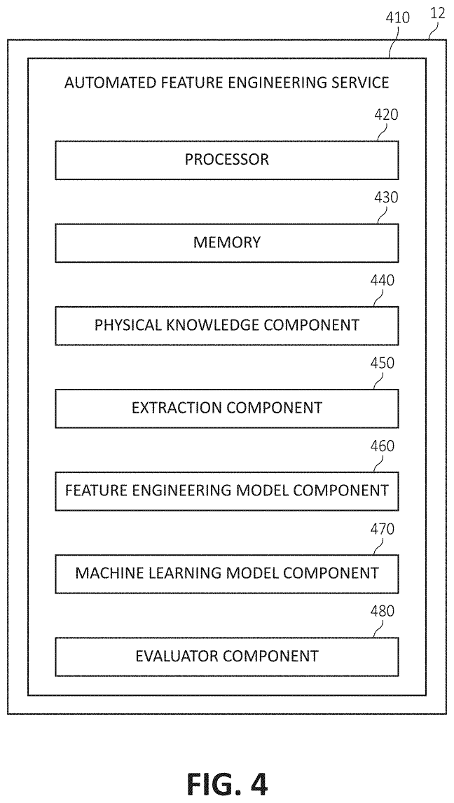

Turning now to FIG. 4, a block diagram depicting exemplary functional components 400 according to various mechanisms of the illustrated embodiments is shown. In one aspect, one or more of the components, modules, services, applications, and/or functions described in FIGS. 1-3 may be used in FIG. 4. Repetitive description of like elements employed in other embodiments described herein is omitted for sake of brevity.

An automated feature engineering service 410 is shown, incorporating processing unit (“processor”) 420 to perform various computational, data processing and other functionality in accordance with various aspects of the present invention. The automated feature engineering service 410 may be provided by the computer system/server 12 of FIG. 1. The processing unit 420 may be in communication with memory 430. The automated feature engineering service 410 may include a physical knowledge component 440, an extraction component 450, a feature engineering model component 460, a machine learning model component 470, and an evaluator component 480.

As one of ordinary skill in the art will appreciate, the depiction of the various functional units in automated feature engineering service 410 is for purposes of illustration, as the functional units may be located within the automated feature engineering service 410 or elsewhere within and/or between distributed computing components.

In general, by way of example only, the automated feature engineering service 410, using the physical knowledge component 440, the extraction component 450, the feature engineering model component 460, the machine learning model component 470, and the evaluator component 480 may learn physical knowledge data associated with a dataset; and transform the physical knowledge data into a plurality of features for one or more automated feature engineering models to execute for one or more prediction and monitoring operations, wherein the plurality of features represent relationships between the physical knowledge data.

The extraction component 450 may receive a dataset and extract various data such as for example, physical knowledge data. The physical knowledge component 440 may translate time series or geospatial data into one or more equations representing and describing behavior of the physical knowledge data, wherein the physical knowledge data includes one or more rules, policies, and laws pertaining to physics, and the one or more equations are used by the one or more automated feature engineering models. An example may include, but not limited to, identifying that data coming from an air quality or nitric oxide (“NOx”) sensor in a city may be represented by and advection-diffusion equation or relationship. With this relationship identified, the raw dataset may be transformed in a more physically robust manner.

The physical knowledge component 440 may represent the physical knowledge data as temporal and spectral features using one or more feature vectors. The physical knowledge component 440, in association with the machine learning model component 470, may identify one or more patterns that match one or more equations describing behavior of the physical knowledge data and the dataset.

The evaluator component 480, in association with the machine learning model component 470, may assign a degree of importance to features in the plurality of features. A score, a range of values, or a percentage may be used to assign the degree of importance. The machine learning model component 470 may be used to determine a degree of importance score (e.g., a scoring phase). The feature engineering model component 460, in association with the machine learning model component 470, may retain those of the features in the plurality of features identified as having a degree of importance greater than a feature importance threshold for the one or more automated feature engineering models.

The feature engineering model component 460, in association with the machine learning model component 470, may validate the one or more automated feature engineering models having one or more equations representing and describing behavior of the physical knowledge data.

It should be noted that after the training phase of an automated feature engineering model, the automated feature engineering service 410 (which may use one or more components described herein such as, for example, the machine learning model component 470) may save the trained automated feature engineering model with necessary information such that the feature engineering processes may be repeated for new data during the scoring phase. The machine learning model component 470 may train an automated feature engineering model to use equations representing the physical knowledge data and newly extracted features.

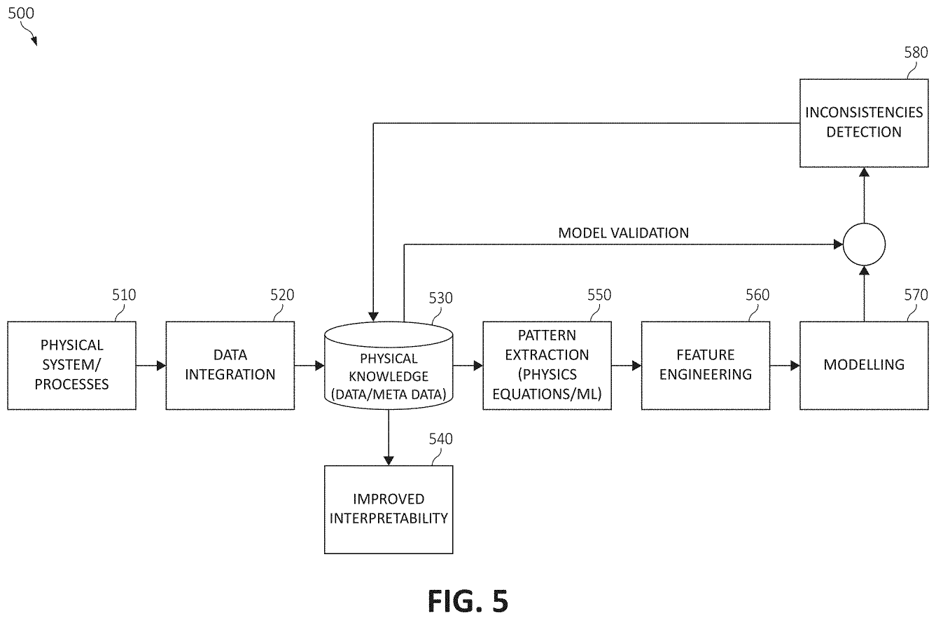

Turning now to FIG. 5, a block diagram 500 depicts exemplary operations for using learned physical knowledge to guide feature engineering. In one aspect, one or more of the components, modules, services, applications, and/or functions described in FIGS. 1-4 may be used in FIG. 5. Repetitive description of like elements employed in other embodiments described herein is omitted for sake of brevity.

Starting in block 510, inputs such as, for example, physical system/processes 510 and data integration 520 may be provided to a physical knowledge database 530. The inputs such as, for example, physical system/processes 510 and data integration 520 may be inputs such as, for example, physics equations, features vector of a system to model, temporal and spectral features, steady state data, and transient stages information, etc.). Alternatively, a system could extract such information from an external database or corpora of scientific literature using data integrators or natural language processing techniques.

The physical knowledge database 530 may categorize the physical descriptors and basis functions that describe the input datasets such as, for example, weather input data (e.g. to a supply chain optimization problem)—rather than providing this data directly to the machine learning model, it might be better characterized in the form of a Navier-Stokes equation representation (e.g., representing the spatial and temporal gradients of the data) and several basis functions (e.g. a sinusoidal component capturing daily patterns of solar radiation/heating) that transform the data into a cleaner dataset that still maintain physical interpretability.

For example, for representing physics laws, applying data and computing loss functions may including the following. A physics laws can be expressed in terms of temporal and spatial derivatives. As an example, advection diffusion equation may be described by a simple formula like the advection diffusion equation:

∂ₜ+∇*Cu=∇*(K*∇C)+S₁ (1),

where S is a source magnitude, C is a concentration of a pollutant and K is the diffusivity? These equations may be arranged in the form:

Xₖ=fₖ(X) (2).

The terms of this type of equation can be directly computed from the data using finite difference methods and the local coefficients solved using matrix methods. Once all the terms in the equations are known, the physics equations can then be applied in the loss function of a neural net training algorithm.

In other implementations, for representing physics laws, applying data and computing loss functions may including the following.

One or more various types of methods may be used by further arranging the equations:

X=\dot{Θ}(X)Ξ (3),

where Ξ is a matrix coefficient, and Θ(X) refers to the component functions of the formula a matrix of coefficients? The equation can be further reduced to:

Xₖ=fₖ(X)=Θ(X^{T})ξₖ (4),

where ξₖ is a vector of coefficients in Ξ. These matrix equations can be solved directly by matrix methods. Their effectiveness in replicating the data can be tested directly on the data. A this point they can be accepted or rejected as valid.

In other implementations, for representing physics laws, applying data and computing loss functions may including the following.

The physics loss may be the error between an output of a network and an ideal compliance (target compliance goal) with a physics equation. For example, using the diffusion equation above, by way of example only, in some implementations, the physics loss may be explained as:

[symbol]

ₚ=∥∂ₜC+∇*Cu−∇*(K*∇C)+∥₂² (5),

The loss function for training of the neural net may be constructed by taking the physics loss and combining it with loss functions such as, for example, a mean square error loss or cross entropy loss for stability purposes. It should be noted that n in the equation below is a weighting parameter for the physics loss:

[symbol]

ₜₒₜ=n [symbol] ₚ+ [symbol] _{MSE} (6),

Thus, for representing physics laws, the above steps for a single physics equation or group of equations may be performed as follows. In step 1), a physics equation may be selected. In step 2), the physics equation may be separated into individual functions and arranged as matrices for computation. In step 3), each component function may be numerically evaluated for some or all data. In step 4), an operation may be performed to solve for coefficients corresponding to each function. In step 5), each equation may be validated against data (e.g., compute mean square error or other metric). In step 6), each equation may be accepted or rejected. In step 7), if the equation is accepted, the equation may be applied to a loss function for training deep neural net on data. A library of known physics can thus be constructed containing the set of functions and the means of their computation for each physics system that is to be considered.

The pattern extraction component 550 may access and use the physical knowledge data and/or metadata from the physical knowledge databased 530 and extract one or more physics equations (e.g., physics equations and machine learning). Pattern extraction in this case refers to processing the raw datasets and identifying pertinent relationships, physical equations, and basis functions in the dataset, that can be processed further by the feature engineering component 560. That is, pattern extraction may refer more generally to the processing of the raw datasets and identifying the given relationships that represent the data. The term “pattern extraction” is used here since it may refer to the extraction of physics equations, basis functions (e.g., sinusoidal or principal component analysis (“PCA”) components), or other periodic dependencies/equations from the data.

The feature engineering component 560 may then analyze and process the extracted physics equations (and/or differential equations) transform the data using the feature engineering to create candidate features from the transformed that may be selected and used for training and modeling, which is used by the modeling component 570. That is, the modeling component 570 may use the candidate features created from the transformed data, which includes the extracted physics equations data and metadata) to train, build, or update one or more machine learning models.

In one aspect, the feature engineering component 560 may conduct feature engineering on the data based on known patterns in the data (e.g., for a drag force computation, one might square the velocity as drag force is proportional to the velocity) or user expertise (e.g., one might implement a log transformation to reduce the variance in the data).

However, in a more advanced approach, the feature engineering component 560 may use the equations extracted from the pattern extraction component 550 (e.g., a pattern matching layer) to implement a set of feature transformations to represent the data. For example, consider outputs from the pattern matching layer that the data (or a subset of the data) has patterns representing, by way of example only, Burgers equation physics, which can be expressed as:

uₜ+uuₓ=∈uₓₓ (7),

Where ∈>0 is the constant of viscosity. If it is assumed that ∈ is equal to zero (e.g., ∈=0, the following hyperbolic partial differential equation (“PDE”) is achieved:

uₜ+uuₓ=0 (8).

Thus, the feature engineering component 560 can adopt components from physics informed neural networks to implement a transformation based on the above knowledge such as, for example:
def f(u, t, x):
u=u(t, x)
u_t=tf.gradients(u, t)[0]
u_x=tf.gradients(u, x)[0]
u_xx=tf.gradients(u_x, x)[0]
f=u_t+u*u_x
return f

The above transformation enables the features to be transformed in the data related to, for example, velocity (u), position (x) and time (t) towards a single output feature, f, based on known relationships in the data. Further the features can be attributed to well-known meta descriptors summarising the data and how they related to modelling (e.g., for this situation, why the transformed Burgers Equation is an important feature encouraging conservation of momentum in the machine learning model.). The transformation of the selected features using the discovered physics equations and basis functions can be done using a variety of AI tools or computational intelligence frameworks or math solvers.

In some aspects, in regard to modelling, the features generated in a feature engineering layer (outputs of the PDE transformation and any basis function representations represented) may be evaluated in terms of improved representation, which can be in terms of ranked feature importance to a machine learning model. In some implementations, this can be feeding a combination of features (e.g., raw features and transformed or generated features of the physics equations) into a machine learning model such as, for example, Random Forest and quantifying feature Importance. Those features identified as being “important” are retained for the machine learning model.

As output from the modeling component 570, the physical knowledge (e.g., physics equations) are pattern matched between the physical equations and the provided data. Using this data, a feedback loop is executed to validate the machine learning models and also provide and detect inconsistencies based on the pattern matching between the physical equations and the provided data (510 and 520) using a detection component 580. Such feedback enables model accuracy and validation, model uplift, or provides and identifies the contribution of each of the features towards machine learning model forecasting.

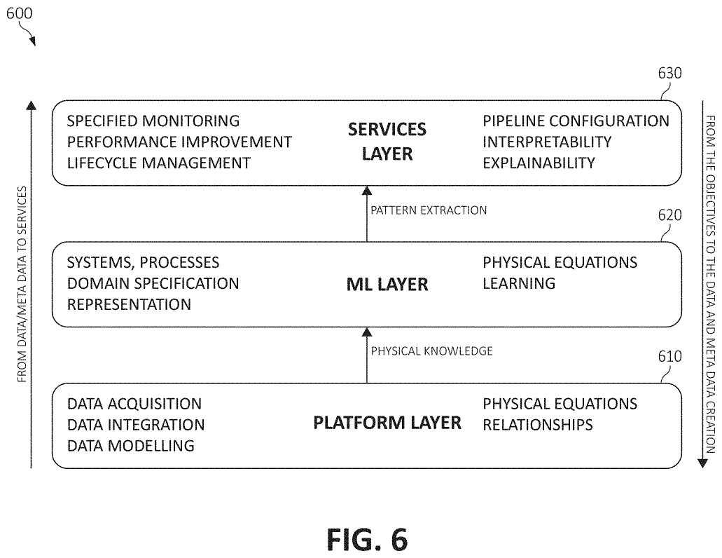

For further explanation, FIG. 6 is a block diagram 600 depicting use of learned physical knowledge to guide feature engineering in a computing environment. In one aspect, one or more of the components, modules, services, applications, and/or functions described in FIGS. 1-5 may be used in FIG. 6. Repetitive description of like elements employed in other embodiments described herein is omitted for sake of brevity.

As depicted, a platform layer 610, a machine learning layer 620, and a services layer 630 may be provided for using learned physical knowledge to guide feature engineering in a computing environment.

The platform layer 610 includes processing and providing data acquisition, data integration, and data modeling. The platform layer 610 also includes maintaining and providing the physics knowledge database having the physics knowledge such as, for example, physical or physics equations and relationships. The platform layer 610 ingests data from a database or an external sensor and processes the data towards a form amenable to machine learning. Basic data cleansing frameworks may be implemented such as outlier removal or data imputation. If meta descriptors of the data exist, these can be provided to a semantic modelling layer that extracts data context to further guide model development. Information on context can be used to guide the selection of appropriate physical equations for the data based on given descriptors (e.g., if the meta descriptors refer to atmospheric datasets, it can be indicative to select from the family of Navier Stokes and advection-diffusion equations). A database of possible physics equations and basis functions are also provisioned and maintained in this platform layer 610. The equations and functions can be stored in a database, provided by the user, or extracted from an external mathematical database or scientific corpora using API connectors or natural language processing from pertinent sources (e.g., an external database/library or a scientific repository).

The physical knowledge learning and processing occurs between the platform layer 610 and the machine learning layer 620. That is, the machine learning layer 620 may use and access the physical knowledge for learning the physics equations, which may be previously hidden to a machine learning model.

The machine learning layer 620 includes knowledge of and access to each of the computing systems, processes, domain specifications and representations. The machine learning layer 620 also includes learning the physics knowledge such as, for example, physical or physics equations and relationships. That is, the machine learning layer 620 may acting upon and relating the extracted physics equations to the input data (e.g., apply physics equations to time series data). The machine learning layer 620 processes the data to 1) identify a set of possible feature transformations or combinations that could be applied to the data based on data-driven discovery of physical relationships, 2) transform the raw dataset based on the identified equations and basis functions, and 3) train and validate the machine learning model on the transformed features and quantify performance score. The machine learning layer 620 selects the optimal combination of features and model configuration that returns the highest performance score.

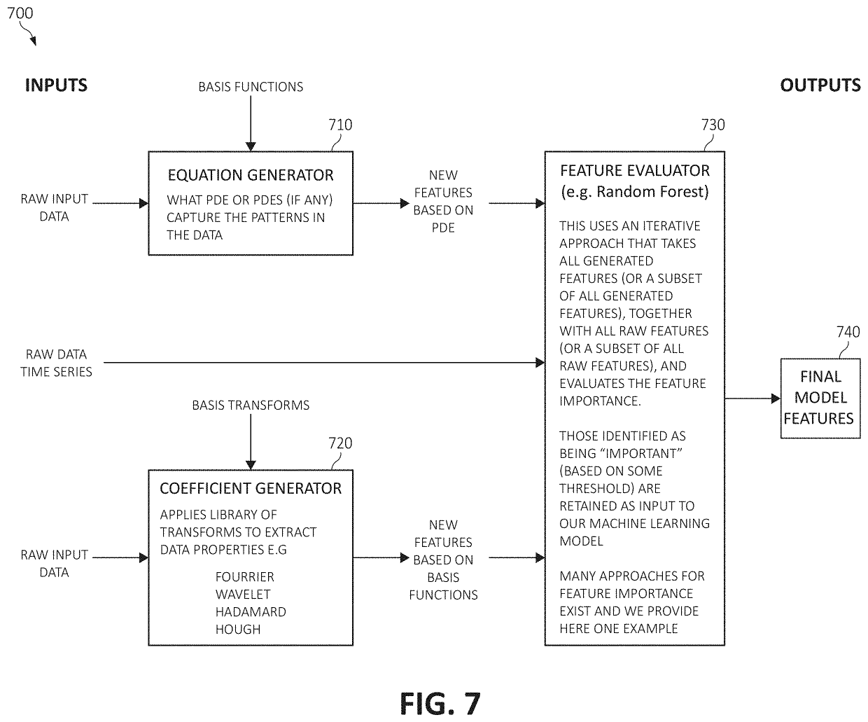

The pattern extractions occurs between the machine learning layer 620 and the services layer 630. That is, the most relevant physical equations are extracted based on the data. That is, the physical equations or difference equations are extracted and prioritized by the machine learning layer 620 based on a match between one or more physical equations and a given data set. Such operations are further summarized in FIG. 7.

The services layer 630 may provide specified monitoring of the machine learning models, performance improvement, and lifecycle management of the machine learning models. The services layer 630 may also allow the user to interface with the trained model through configuration, interpretability, and explainability. The services layer 630 may also provide for detecting the inconsistencies in the machine learning models. The services layer 630 may evaluate the machine learning models with the given inputs or data and identify machine learning model inconsistency and for identifying improved or decreased machine learning model performance based on the given feature engineering and transformations. Aspects related to model monitoring, management, and interpretation are provisioned within this services layer 630. Model interpretation or explainability can be provided in terms of the physical equations identified for the system. This allows the user to interpret how the raw data influences model performance and how the transformed features based on the identified physical equations and basis functions influence performance. The advantage of this approach is that it allows for a more physically consistent interpretation of model results and performance compared to a naive data transformation approach.

For further explanation, FIG. 7 is a block diagram 700 depicting an additional exemplary operations using learned physical knowledge to guide feature engineering in a computing environment according to an embodiment of the present invention. In one aspect, one or more of the components, modules, services, applications, and/or functions described in FIGS. 1-5 may be used in FIG. 6. Repetitive description of like elements employed in other embodiments described herein is omitted for sake of brevity.

As depicted, an equation generator 710 may receive input data (e.g., raw input data) and using one or more basic functions, generate one or more equations such as, for example, determining and generating one or more equations (e.g., partial differential equation (“PDE”) or PDEs (if any) that capture the patterns in the data. Also, new features may be learned and extracted based on the PDEs and provided to a feature evaluator 730.

A coefficient generator 720 may also receive input data (e.g., raw input data) and applies a library transforms (or transformations) to extract one or more data properties (e.g., Fourier, wavelet, Hadamard, Hough, etc.). Also, new features may be learned and extracted based on the functions and provided to a feature evaluator 730.

The feature evaluator 730 (e.g., random forest) may use an iterative approach that takes all generated features (or a subset of all generated features) from the equation generator 710 and the coefficient generator 720, together with all raw features (or a subset of all raw features) and evaluates the feature importance. Those identified as being “important” (based on some threshold) are retained as final machine learning model features 740 and then used as input to a machine learning model and provided.

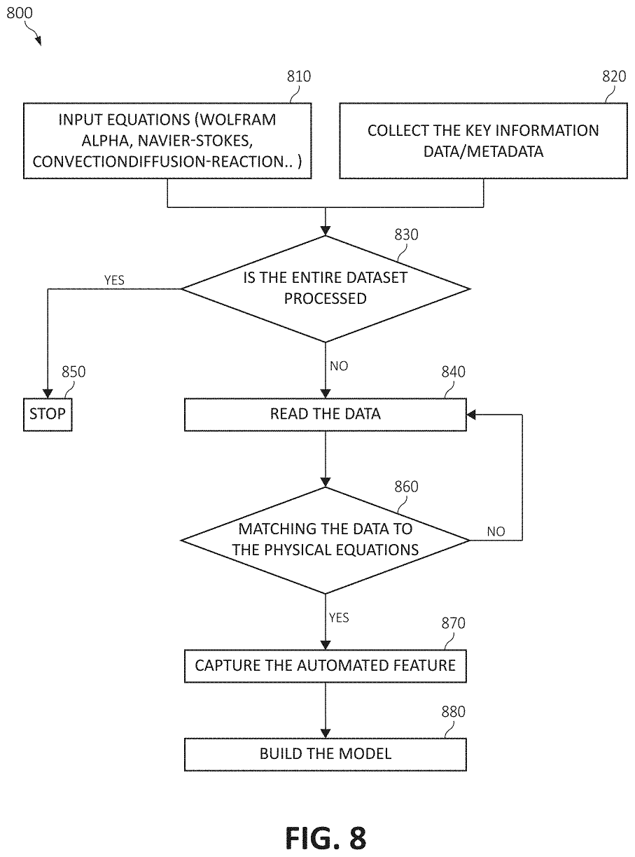

FIG. 8 is a flowchart diagram depicting an exemplary method 800 using learned physical knowledge to guide feature engineering in a computing environment. In one aspect, each of the devices, components, modules, operations, and/or functions described in FIGS. 1-7 also may apply or perform one or more operations or actions of FIG. 8. The functionality 800 may be implemented as a method executed as instructions on a machine, where the instructions are included on at least one computer readable medium or one non-transitory machine-readable storage medium.

The functionality 800 may start in block 810 where one or more input equations (e.g., wolfram, alpha, Navier-stokes, convention diffusion-reaction type equations) may be collected and processed. In parallel to or independent from block 810, key information (e.g., data and metadata) may be collected, as in block 820. The data from both 810 and 820 may be received and analyzed to determine if the entire dataset is processed, as in block 830. If yes, the method 800 may end, as in block 850. If no at block 830, the data may be read, as in block 840. An operation may be performed to determine if the data (e.g., data from block 820) matches the physical equations (e.g., equations from block 810), as in block 860. If no, the method 800 returns to block 840. If yes, the method moves to block 870 where one or more automated features are captured.

Using the captured automated features, a machine learning model may be built, as in block 880.

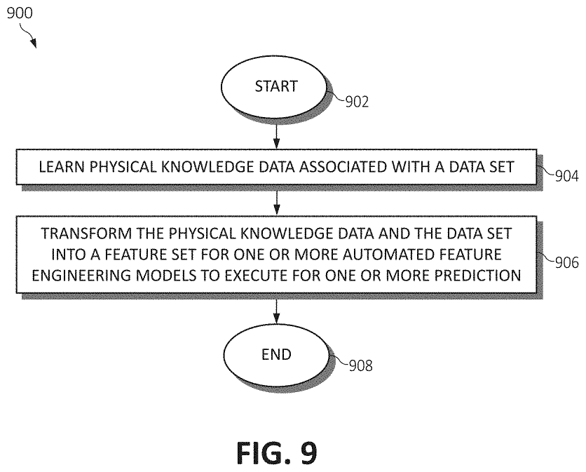

FIG. 9 is a flowchart diagram depicting an exemplary method using learned physical knowledge to guide feature engineering in a computing environment. In one aspect, each of the devices, components, modules, operations, and/or functions described in FIGS. 1-8 also may apply or perform one or more operations or actions of FIG. 9. The functionality 900 may be implemented as a method executed as instructions on a machine, where the instructions are included on at least one computer readable medium or one non-transitory machine-readable storage medium. The functionality 900 may start in block 902.

Physical knowledge data associated with a dataset may be learned, as in block 904. The physical knowledge data may be translated into a plurality of features for one or more automated feature engineering models to execute for one or more prediction and monitoring operations, where the plurality of features represent relationships between the physical knowledge data, as in block 906. In one aspect, the functionality 900 may end, as in block 908.

In one aspect, in conjunction with and/or as part of at least one block of FIG. 9, the operations of method 900 may include each of the following. The operations of method 900 may translate time series data into one or more equations representing and describing behavior of the physical knowledge data, where the physical knowledge data includes one or more rules, policies, and laws pertaining to physics, and the one or more equations are used by the one or more automated feature engineering models.

The operations of method 900 may represent the physical knowledge data as temporal and spectral features using one or more feature vectors. The operations of method 900 may identify one or more patterns that match one or more equations describing behavior of the physical knowledge data and the dataset. The operations of method 900 may assign a degree of importance to features in the plurality of features.

The operations of method 900 may retain those of the features in the plurality of features identified as having a degree of importance greater than a feature importance threshold for the one or more automated feature engineering models. The operations of method 900 may validate the one or more automated feature engineering models having one or more equations representing and describing behavior of the physical knowledge data.

The present invention may be a system, a method, and/or a computer program product. The computer program product may include a computer readable storage medium (or media) having computer readable program instructions thereon for causing a processor to carry out aspects of the present invention.

The computer readable storage medium can be a tangible device that can retain and store instructions for use by an instruction execution device. The computer readable storage medium may be, for example, but is not limited to, an electronic storage device, a magnetic storage device, an optical storage device, an electromagnetic storage device, a semiconductor storage device, or any suitable combination of the foregoing. A non-exhaustive list of more specific examples of the computer readable storage medium includes the following: a portable computer diskette, a hard disk, a random access memory (RAM), a read-only memory (ROM), an erasable programmable read-only memory (EPROM or Flash memory), a static random access memory (SRAM), a portable compact disc read-only memory (CD-ROM), a digital versatile disk (DVD), a memory stick, a floppy disk, a mechanically encoded device such as punch-cards or raised structures in a groove having instructions recorded thereon, and any suitable combination of the foregoing. A computer readable storage medium, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

Computer readable program instructions described herein can be downloaded to respective computing/processing devices from a computer readable storage medium or to an external computer or external storage device via a network, for example, the Internet, a local area network, a wide area network and/or a wireless network. The network may comprise copper transmission cables, optical transmission fibers, wireless transmission, routers, firewalls, switches, gateway computers and/or edge servers. A network adapter card or network interface in each computing/processing device receives computer readable program instructions from the network and forwards the computer readable program instructions for storage in a computer readable storage medium within the respective computing/processing device.

Computer readable program instructions for carrying out operations of the present invention may be assembler instructions, instruction-set-architecture (ISA) instructions, machine instructions, machine dependent instructions, microcode, firmware instructions, state-setting data, or either source code or object code written in any combination of one or more programming languages, including an object oriented programming language such as Smalltalk, C++ or the like, and conventional procedural programming languages, such as the “C” programming language or similar programming languages. The computer readable program instructions may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider). In some embodiments, electronic circuitry including, for example, programmable logic circuitry, field-programmable gate arrays (FPGA), or programmable logic arrays (PLA) may execute the computer readable program instructions by utilizing state information of the computer readable program instructions to personalize the electronic circuitry, in order to perform aspects of the present invention.

Aspects of the present invention are described herein with reference to flowchart illustrations and/or block diagrams of methods, apparatus (systems), and computer program products according to embodiments of the invention. It will be understood that each block of the flowchart illustrations and/or block diagrams, and combinations of blocks in the flowchart illustrations and/or block diagrams, can be implemented by computer readable program instructions.

These computer readable program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks. These computer readable program instructions may also be stored in a computer readable storage medium that can direct a computer, a programmable data processing apparatus, and/or other devices to function in a particular manner, such that the computer readable storage medium having instructions stored therein comprises an article of manufacture including instructions which implement aspects of the function/act specified in the flowchart and/or block diagram block or blocks.

The computer readable program instructions may also be loaded onto a computer, other programmable data processing apparatus, or other device to cause a series of operational steps to be performed on the computer, other programmable apparatus or other device to produce a computer implemented process, such that the instructions which execute on the computer, other programmable apparatus, or other device implement the functions/acts specified in the flowchart and/or block diagram block or blocks.

The flowchart and block diagrams in the Figures illustrate the architecture, functionality, and operation of possible implementations of systems, methods, and computer program products according to various embodiments of the present invention. In this regard, each block in the flowchart or block diagrams may represent a module, segment, or portion of instructions, which comprises one or more executable instructions for implementing the specified logical function(s). In some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer instructions.

1. A method, by a processor, for providing enhanced feature engineering in a computing environment, comprising:
learning physical knowledge data associated with a dataset; and
transforming the physical knowledge data into a plurality of features for one or more automated feature engineering models to execute for one or more prediction and monitoring operations, wherein the plurality of features represent relationships between the physical knowledge data.

2. The method of claim 1, further including translating time series data into one or more equations representing and describing behavior of the physical knowledge data, wherein the physical knowledge data includes one or more rules, policies, and laws pertaining to physics, and the one or more equations are used by the one or more automated feature engineering models.

3. The method of claim 1, further including representing the physical knowledge data as temporal and spectral features using one or more feature vectors.

4. The method of claim 1, further including identifying one or more patterns that match one or more equations describing behavior of the physical knowledge data and the dataset.

5. The method of claim 1, further including assigning a degree of importance to features in the plurality of features.

6. The method of claim 4, further including retaining those of the features in the plurality of features identified as having a degree of importance greater than a feature importance threshold for the one or more automated feature engineering models.

7. The method of claim 1, further including validating the one or more automated feature engineering models having one or more equations representing and describing behavior of the physical knowledge data.

8. A system for providing enhanced feature engineering in a computing environment, comprising:
one or more computers with executable instructions that when executed cause the system to:
learn physical knowledge data associated with a dataset; and
transform the physical knowledge data into a plurality of features for one or more automated feature engineering models to execute for one or more prediction and monitoring operations, wherein the plurality of features represent relationships between the physical knowledge data.

9. The system of claim 8, wherein the executable instructions that when executed cause the system to translate time series data into one or more equations representing and describing behavior of the physical knowledge data, wherein the physical knowledge data includes one or more rules, policies, and laws pertaining to physics, and the one or more equations are used by the one or more automated feature engineering models.

10. The system of claim 8, wherein the executable instructions that when executed cause the system to represent the physical knowledge data as temporal and spectral features using one or more feature vectors.

11. The system of claim 8, wherein the executable instructions that when executed cause the system to identify one or more patterns that match one or more equations describing behavior of the physical knowledge data and the dataset.

12. The system of claim 8, wherein the executable instructions that when executed cause the system to assign a degree of importance to features in the plurality of features.

13. The system of claim 12, wherein the executable instructions that when executed cause the system to retain those of the features in the plurality of features identified as having a degree of importance greater than a feature importance threshold for the one or more automated feature engineering models.

14. The system of claim 8, wherein the executable instructions that when executed cause the system to validate the one or more automated feature engineering models having one or more equations representing and describing behavior of the physical knowledge data.

15. A computer program product for providing enhanced feature engineering in a computing environment, the computer program product comprising:
one or more computer readable storage media, and program instructions collectively stored on the one or more computer readable storage media, the program instruction comprising:
program instructions to learn physical knowledge data associated with a dataset; and
program instructions to transform the physical knowledge data into a plurality of features for one or more automated feature engineering models to execute for one or more prediction and monitoring operations, wherein the plurality of features represent relationships between the physical knowledge data.

16. The computer program product of claim 15, further including program instructions to translate time series data into one or more equations representing and describing behavior of the physical knowledge data, wherein the physical knowledge data includes one or more rules, policies, and laws pertaining to physics, and the one or more equations are used by the one or more automated feature engineering models.

17. The computer program product of claim 15, further including program instructions to represent the physical knowledge data as temporal and spectral features using one or more feature vectors.

18. The computer program product of claim 15, further including program instructions to identify one or more patterns that match one or more equations describing behavior of the physical knowledge data and the dataset.

19. The computer program product of claim 15, further including program instructions to:
assign a degree of importance to features in the plurality of features; and
retain those of the features in the plurality of features identified as having a degree of importance greater than a feature importance threshold for the one or more automated feature engineering models.

20. The computer program product of claim 15, further including program instructions to validate the one or more automated feature engineering models having one or more equations representing and describing behavior of the physical knowledge data.
